(19) United States
(12) Patent Application Publication
(10) Pub. No.: US 2013/0125824 A1
(43) Pub. Date: May 23, 2013

(54) Platform associated with various water treatment and replenishment devices

(71) Applicant: Barry Lee Farris, Pollock Pines, CA (US)

(72) Inventor: Barry Lee Farris, Pollock Pines, CA (US)

(21) Appl. No.: 13/135,334

(22) Filed: Jun. 30, 2011

Related U.S. Application Data
(60) Provisional application No. 61/404,191, filed on Sep. 30, 2010.

(51) Int. Cl. A01K 7/00; B05B 1/00; F16M 11/00

(52) U.S. Cl. CPC A01K 7/00; F16M 11/00; B05B 1/00
USPC 119/72.5; 248/346.01; 239/589

(57) ABSTRACT

A easily removable platform like structure with various access holes and openings that is located above a water supply that provides a path to the water to allow the passage and support of devices to treat water and maintain a predefined water level.

### CROSS REFERENCE CLAIMING THE BENEFIT OF AN EARLIER FILING DATE UNDER 35 U.S.C. 120 AND 119(E) [R-5]

I claim the benefit of two earlier provisional applications with the first application Ser. No. 29/370,457 and dated Jul. 19, 2010. The second provisional application is numbered 61/404,191 and is dated Sep. 30, 2010.

### STATEMENT REGARDING FEDERALLY SPONSORED RESEARCH OR DEVELOPMENT.

N/A

### BACKGROUND OF THE INVENTION, PET FOUNTAINS AND REVIEW OF THE PRIOR ART

It is believed that the first pet fountain was a product called Kitty Kreek which was perhaps advertized as early as 1995. The initial benefit for a pet fountain was thought to stimulate the water consumption by attracting a pet to the water supply with the sight and sound of falling water. While there is no evidence of falling water stimulating water consumption in nature, the advertizing claim did motivate pet owners to buy something for their beloved pet to replace a simple bowl of room temperature tap water. Initially, the most successful fountain was called The Drinkwell which cashed in on the purported preference of cats wanting to drink water falling from a dripping or running household faucet. The inventors of the Drinkwell received the U.S. Pat. No. 5,799,609, which was issued in September 1998 covering the concept of “Free Falling Water”. A request for reexamination of the '609 patent was accepted in July 2010.

Dozens of competing pet fountains were sold attempting to provide attractants that might cause a pet to drink more water. Due to consumer complains, almost all fountains added a refill design to their original design to offset the water lost to evaporation, spilling and consumption of the water. To date, most, if not all, refill designs were made of plastic which were very difficult to keep clean due to the porous nature of the plastics and the awkward and inaccessible angles within the refill containers. The methods to cause water to flow from the refill container to the open container caused many problems with water overflowing onto the floor because the moving part of the flow design would often become stuck in the open position due to the mechanism being damaged in the normal course of adding water to the refill container or the mechanism becoming impaired due to water impurities such as calcium deposits or the buildup of algae or the effect of cleaning measures such a chlorine bleach or heat. The customer feedback concerning overflow reported on websites such as Amazon caused many customers to throw out their fountains in just a few months so to avoid the more serious dangers of slip and fall, damaging expensive wood floors or electrocution.

The common sense issue of chilling the water to below ambient temperature to increase the water consumption has been attempted by adding ice cubes or by freezing the water within the refill container. The practice of adding ice cubes to reduce the water temperature usually had a limited and short term effect and is very impracticable when the owner works outside the home or takes a weekend trip. Freezing the refill container was found to damage the refill container as well as the flow restricting mechanism requiring replacing the refill system which could cost as much as the entire fountain.

The dynamics of causing the flow of the water so as to initially attract a pet and then cause a pet to drink was limited by the patent claims of the '609 so the other makers usually made their flow of water not to “free fall” but to be in constant contact with the materials used to manufacture the fountain and therefore causing the water to slide down a ramp rather than fall. The owners of the '609 aggressively attacked almost every would-be competitor. The owners of the '609 patent did not license their “free falling” claim so almost all other products were self limited to having their water quietly slip down a ramp into the pet accessible container which was located below the elevated water area. The amount of flow for most products was adjustable by placing flow restrictors in front of the intake area of the pump which often caused an unacceptable amount of pump noise due to cavitation. No product provided any means of adjusting the direction of the flow.

### BRIEF SUMMARY OF THE INVENTION

In accordance with one embodiment a platform that spans over a water supply that supports a sterilizable refill system while also providing various openings and structures that can produce a continues flow of cold, filtered, medicated and sterilized water for a pet.

### ADVANTAGES

An electrically non conductive and easily removed platform that can span all or part of a container of water or be attached to an outside wall and then hung over an open container of water and said platform can support and provide

1. Support for one or more sterilizable and economically replaced glass refill bottles that can refill the water consumed by animals or lost to evaporation

2. A Yorker spout that is modified so as to provide a quiet and safe method of adding water to the container while also preventing noise and preventing a potential overflow because of the angled modification.

3. Support for a product such as an Ice Probe™ sold by NovaTec™ can be placed in any one of the available holes so as to chill the water below the ambient air temperature.

4. A system of tubing that pulls water from the container and then pumps the water to distant areas of cold temperatures such as a refrigerator, freezer or even a toilet tank and then inserting tubes that are highly thermally conductive, such as copper, the water coming from the container is cooled in the colder environment and then returned to the container much colder than when the water left the container.

5. A support for a closed system of flexible tubing that removes water from the container via a common aquarium pump and then pumps the water through the cold side of a thermoelectric device which has been formed so that a tube of highly thermally conductive material, such as copper, can be sandwiched between two plates that are part of the cold side of a thermoelectric chilling device using what is commonly called the Peltier effect to cause the cooling effect usually using a common water block, heat sink or heat exchanger.

6. A location to place an empty tube that is closed on the end and that the closed end can sit into the water in the container and be filled with cold materials such as ice cubes into the open end to cool the water in the container without adding water to the container as the ice melts.

7. A platform to allow various methods to sterilize the water that naturally flows by due to the relative distant locations of the intake and outflow of one or more pumps or the sterilization method such as UV light can be inline using one or the pumps to create a flow through the UV light much like the inline sterilizing products used to keep aquarium water microbiologically clean.

8. A platform to hold, horizontally, and anchor a tube filled with charcoal or other filter material with an elbow at the distal end that is adjustable from pointing straight up, for the maximum in noise and stream of water, to straight down, for the quietest water noise and least potential for splashing, or at any angle between or direction in a single plane of 360 degrees.

9. a platform where a hole can be utilized to anchor a tube filled with charcoal or other filter media in a vertical position and the elbow can be moved to direct the stream of water away from the centerline or a tube can be affixed to the end of the elbow to direct the flow into the water with little, if any, splash or noise.

10. A platform that anchors a very small pump that pumps water from the container and then through the high temperature side of a thermoelectric device and or the transformer/ power supply used to change 110 v or 220 v to the required 12 v to operate the thermoelectric chiller, so that at a minimum time exposure is at least 16 seconds at 72° C. or other effective time and temperature, so most all microorganisms will be destroyed.

11. A platform that can be easily lifted off or rotated to the rear or to the side with one or more or all of the devices being also lifted off in the process so that the water container may quickly and easily be effectively cleaned or sterilized.

12. A platform that can support a bag like container at or below the water level which contains medications or other chemicals that can be delivered to the water supply.

### BRIEF DESCRIPTION OF THE SEVERAL VIEWS OF THE DRAWINGS

FIG. 1 is a perspective view of a platform to hold and/or support varies devices to clean, sterilize, medicate and cool the water in a container to water pets

FIG. 2 is a perspective view of some of the devices that could be supported on the platform

FIG. 3 is a drawing of a Yorker spout cap with the modification shown

FIG. 4 is a drawing of a shelf that can perform all of the functions of the platform and how the shelf might be attached to an object such as a wall or wood cabinet.

FIG. 5 is a perspective drawing of a platform with an extended area to provide for the location of various electronic devices such as a TEC or a power supply

FIG. 6 is a perspective drawing of one shape of a water container with a carbon filter with an adjustable nozzle, spout and cap and a refill bottle

FIG. 7 is a cross section, Z-Z, showing the relationship of the hole, 110, modified inverted Yorker cap and spout, 230, and the inverted refill bottle, 240.

### DETAILED DESCRIPTION OF THE INVENTION

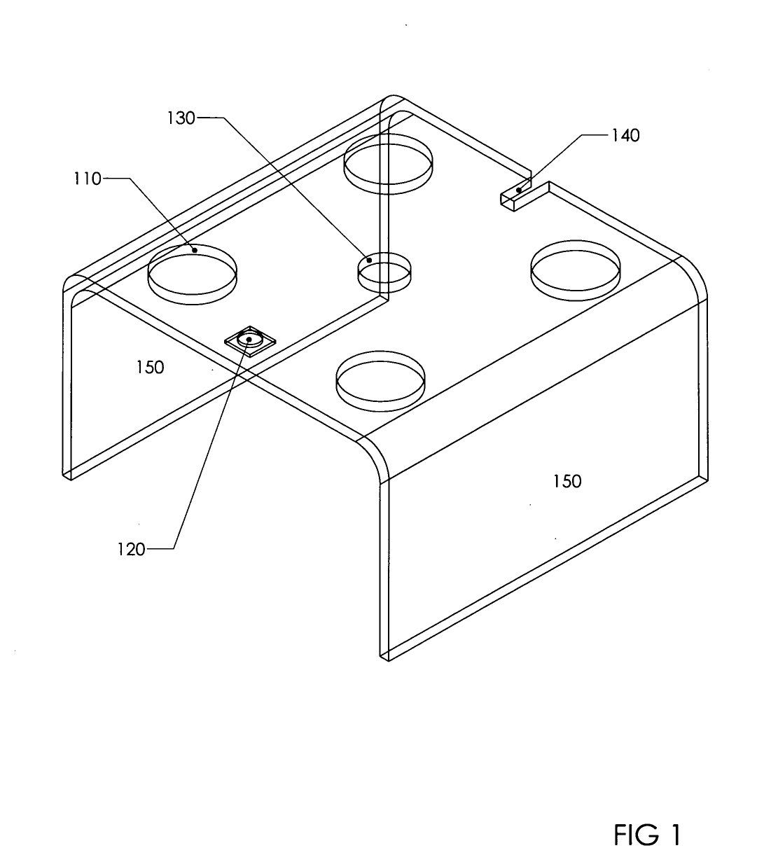

One embodiment shown in FIG. 1 is 150 is a free-standing platform structure that supports various devices to clean, cool, sterilize and furnish replenishment water for a pet fountain. Further in FIG. 1 is 110 which is a hole that has been cut or molded in the material that forms 150. The hole may be cut in the material that makes 150 in a secondary operation, or 110 could be part of the mold that could make 150. 110 can support many embodiments, such as an Ice Probe™ chiller (sold by NovaTec of San Rafael, Calif.) 210B and a Yorker spout cap 230 while when combined with a bottle 240 can provide a refill supply of water in a quiet manner and without the possibility of the water from the bottle 240 rushing out and flooding the surface below the pet fountain. Further, 110 has other uses, such as holding a ultra-violet sterilizer lighting tube that passes through 110 into the container of water, which 630 is just one possible configuration for the container of water. 110 can also be used as a pass-through for tubing from 530 and/or 520.

The hole 110 also is meant to hold 230, which is a Yorker spout and cap combination that has been trimmed by the sharp 90 degree angle of hole 110, and also trim the ribs, 310B, of 310. The trimming of 310B is accomplished by having the hole 110 cut or molded at a precise 90-degree angle in material that is structurally strong enough to modify or trim the ribs 3108, thereby forming a tight seal and preventing instability when a bottle 240 is threaded into the cap portion of 230 and filled with water.

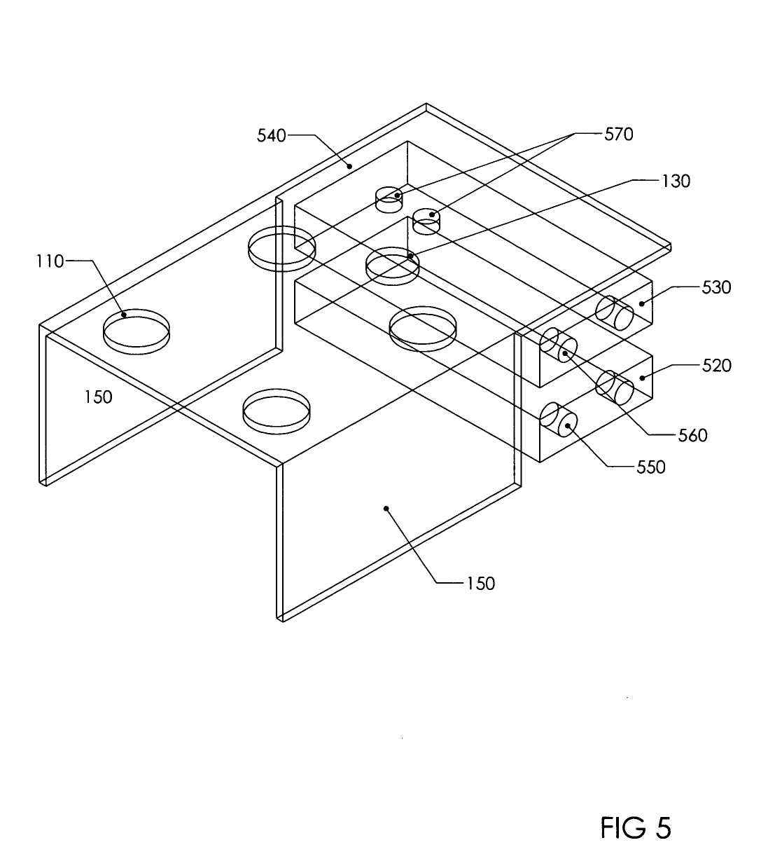

FIG. 1 also shows 120 which is a structure intended to stabilize the front of 220 which is a tube filled with charcoal or other filtering media, by the use of a strapping material inserted through one of the many available slots of 120. Presently, the 120 object is distributed by Home Depot and is labeled on the package as stock number 296167 with a nomenclature of a Mounting Device. FIG. 1 also shows 130 which is the rear anchoring hole for the rear elbow of the filter 220. Also shown in FIG. 1 is 140 which is a semi-circle or slot or notch meant to anchor or restrict movement of an electrical cord such as when a submergible pump is put in the bottom of a water container, one embodiment of which is 630. The 140 opening is also a good place to serve as a pass through for the tubing coming from and returning to the devices 520 and 530 as shown in FIG. 5.

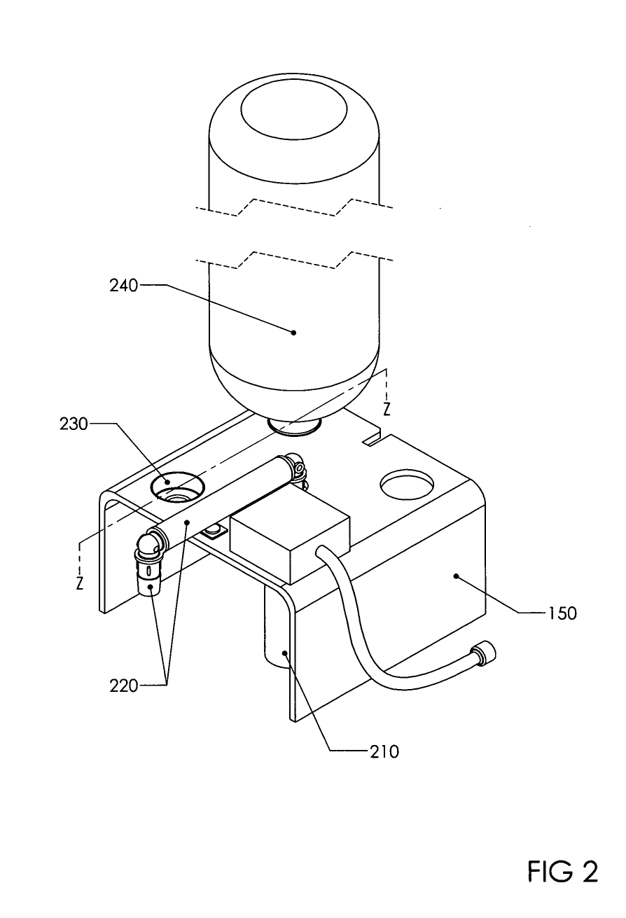

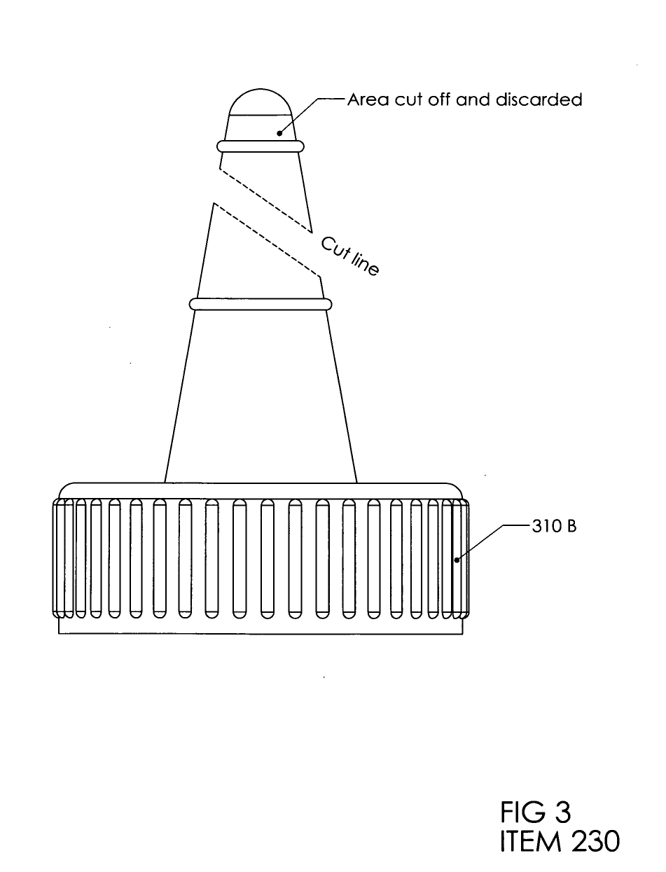

FIG. 2 shows the location and orientation of the thermoelectric chiller (“TEC”), labeled as 210 presently supplied by NovaTec of San Rafael, Calif., that is mounted in one of the holes 110 of the part labeled as 150. The probe 210 passes through the hole 110 and rests in the water of whatever container is below the top of platform 150. Also in FIG. 2 is 230 which is a spout and cap combination commonly known as a Yorker cap and spout which has been modified as shown as FIG. 3 and which is seated into hole 110 in such a manner that the ribs of 310B are gently trimmed to form a very stable combination. To attempt to avoid any confusion, the cap and spout labeled as 230 is different from the cap and spout labeled as 310 in that the trimming and seating resulting from pushing the 310 into 110 will trim off the tops of most if not all of the ribs in the undulating design that encircles the cap portion of the cap and spout. The item 230 also has been modified as shown in 310A. The 230 cap and spout are easily removable for other purposes such as being used as a pass through for cold and/or hot water harvested from the 520 and/or 530 using a device that has many names such as a water block or heat sink or heat exchanger all of which are commonly available via the internet and one supplier is cite number 6 in the form 10-6B. FIG. 2 also shows an inverted bottle 240 and is threaded into 230. In FIG. 2, 220 is a carbon filter horizontally mounted on the top of platform 150 which includes an elbow that is not fixed and fully adjustable to any angle in one 360-degree plane.

FIG. 3 is a Yorker spout and cap, originally manufactured by Yorker Packaging of Greenville, S.C. (also drawn in cite number 8 of form 10-6B) with an angle, 310A cut across the spout portion of 310 and the angle created prevents the overfilling of the water container as well as quieting the noise of water leaving the bottle 240 into the container below. FIG. 3 also shows 310B which is an undulating system of plastic ribs that has a diameter that is 0.03 inches larger (as shown in cite number 8 of form 10-6B) than the diameter of hole 110 so that when the soft plastic used to manufacture 310 and the resulting 310B is inserted into the hole 110, the rigid material used to manufacture 150, such as 3/16″ ABS plastic, will trim the raised portion of the ribs 310B and thereby provide a stable platform when the glass, or plastic bottle 240 is filled with tap water, distilled water or therapeutic water.

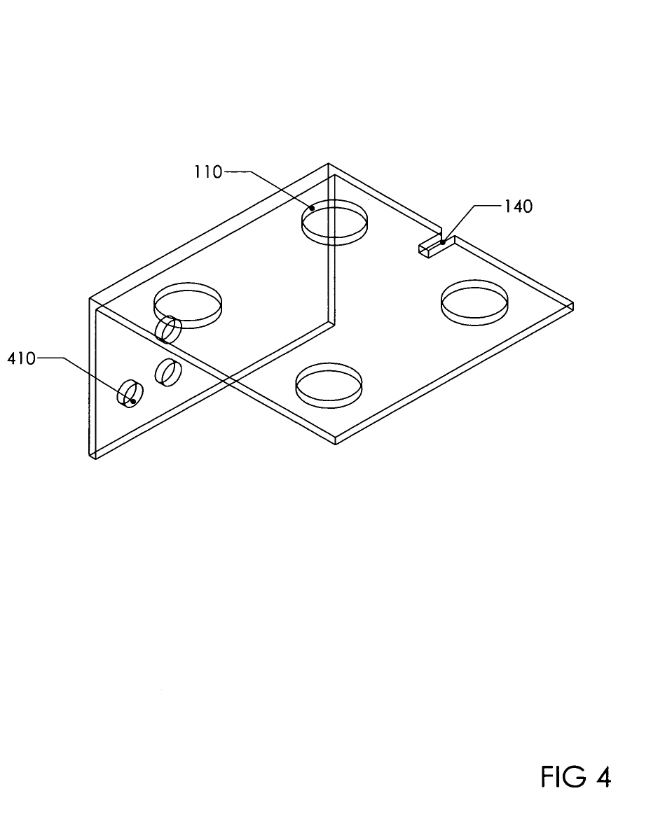

FIG. 4 is a drawing of 150 without one leg when it becomes advantageous to permanently mount the top of the platform and all attendant features which is accomplished by using the holes 410 to mount the shelf permanently, such as a wall or cabinet, as shown in FIG. 4.

FIG. 5 is a drawing showing an extension, 540, on the rear of 150 which provides an enclosure to prevent water, dust or access by pets to numerous electronic components including, but not limited to, a TEC 530 and the power supply 520 to support the operation of 530. FIG. 5 includes many fitting areas such as 550, 560, and 570 which are to harvest cold water that will be deposited into the water container and also harvest the heat from both 530 and 520 into a micro-bore array that will sterilize the circulating water that will be returned to the water container. In FIG. 5, there are two items labeled 510 which are the left and right walls shown in 150, with the only difference being the extension 540.

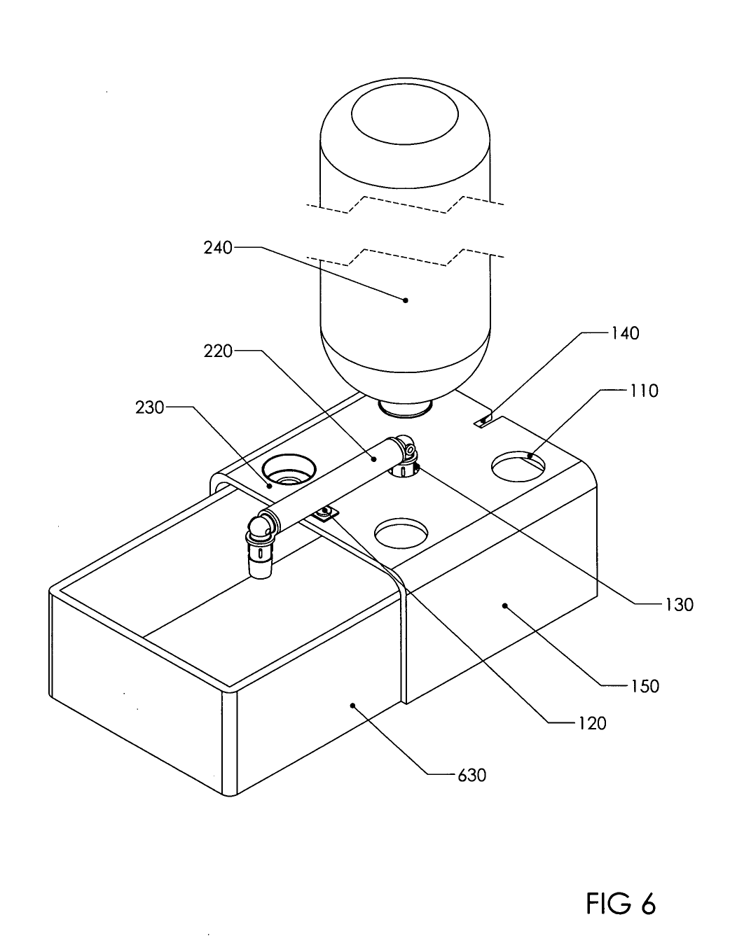

FIG. 6 shows how the free standing platform 150 would look if the water container was a separate rectangular-shaped container to hold drinking water. There is a space that is intentionally created by having the span of 150 be greater than the width of the water container, in this case 630, thereby allowing air flow and the resultant cooling effect due to the evaporation of sweat from the water container because the temperature of the water contained in the water container will be less than the ambient room temperature. Another useful embodiment is to locate electronic devices such as a TEC 530 and its power supply 520 and perhaps additional inline pumps under the water container so long as these items are protected from any water spilling over the side of the water container or from the water container sweating as well as isolating the components from pets and children.

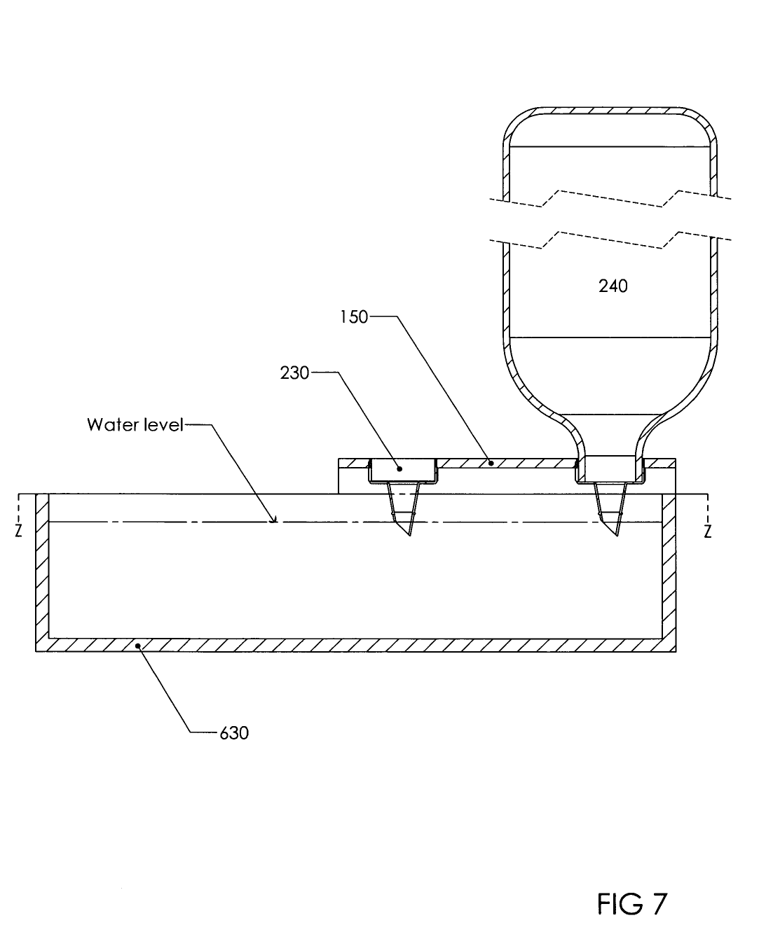

FIG. 7 is a cross section, Z-Z, showing the relationship of the hole, 110, with the inverted modified Yorker, 230, and the inverted bottle, 240, threaded into 230 and also where the water level would normally be when the platform, 150, is spanning a container, 630 (in this example).

### Operation of the Pet Fountain Shown in FIG. 1 through 6

The first step for the pet owner to do is to fill the water container, in this case 630, with water to within “A” from the lip of the wall. At this point, the owner will place a submergible pump at the bottom of the water container so that a vertically-oriented outlet will enter through 130 and frictionally mate into the rear elbow of 220. In a useful embodiment, the tubing 550, 560 and 570 that contain harvested cold or hot water, plus the return water tubing, as the devices 520 and 530 are self contained, would be already anchored in notch similar to 140, allowing the simultaneous sterilization and chilling of the water that was pumped from the container, through the heat sink/water block/heat exchanger and then returned to the container in a closed loop. At this point, one or more of the refill bottles would be filled with water and inverted and threaded into the cap-spout combination 230. Finally, all the electrical powered components would be turned on.

I claim:

1. A platform that spans across part or all of a water container with a plurality of passages to anchor certain movements of a plurality of water treatment devices.

2. The platform of claim 1 wherein provides a quiet and safe method and means to replenish the water that is lost to consumption and evaporation.
a. The claim of 2 that uses a Yorker cap and spout combination that when modified by cutting an angle into the spout allows water to go down and simultaneously allowing air to replace the volume of water in a quiet and non violent manner thereby preventing too much water leaving the refill container and then overflowing the container while also accomplishing the refill operation quietly so as not to startle an animal or wake a sleeping human. The angle cut into the spout is greater than 0 degrees from the longitudinal axis of the spout and less than 90 from the same axis much like the cut line shown in FIG. 3.

3. The platform of claim 1 providing a method and means to chill the water below the ambient air temperature.
a. The platform of claim 3 that has a hole in the platform that will provide access to the water in the container so that the cold end of a thermoelectric chiller such as The Ice Probe™ which is sold by NovaTec Inc. can be located in the water and thereby chill the water while the rest of the Ice Probe™ sits atop the platform.
b. The platform of claim 3 that has a hole that will allow access to the water below allowing a hollow tube that has one end closed off can be passed through the hole and be kept in a vertical position while a form of frozen or chilled substances such as ice cubes can be inserted inside the open top of the hollow tube and after the thermo transfer is complete, the formally chilled or frozen substance can be discarded and replenished with a new amount of the chilled or frozen substance from a refrigerator or freezer without adversely affecting the level of water in the container as the water in the container and the chilled or frozen substance never mix.
c. The platform of claim 3 that has an extension added to one end of the horizontal platform and said extension does not span any part of the water container and is a protective housing that may contain a thermoelectric chilling device that has a water block attached to the cold side where water from the container is pumped through the water block and then the water is returned while be anchored to the platform and then to the container colder than when the water left the container.
d. The platform of claim 3 that has a plurality of holes that will provide a location for a modified and then inverted Yorker spout cap which in turn will allow the threading on of an inverted bottle, preferably glass and finding a new use of repurposed bottles or recycled glass bottles that has been filled with water and then chilled in a common refrigerator so that with a constant reduction of the water level in the container due to consumption of the water and evaporation, the refill bottle will provide cold water at or near 40 degrees Fahrenheit thereby keeping the water cool relative to the ambient room temperature and desirable for an animal to drink and thereby keeping the water dependent organs of the body perfused with the optimal amount and physiologically correct amount of water.
e. The platform of the above claim has another useful purpose relative to cooling the water within the container, as the platform can be an anchor for a system of tubing that pulls water from the container using a pump and then the tubing has a section of heat transferring material, such as copper pipe, which is inserted into a cold environment such as the tank of a common toilet or through the walls of a common refrigerator where the warmer temperature of the water that is pumped from the toilet tank or refrigerator is reduced due to the thermal conductivity and heat exchanging capabilities of the thermal conductive material that was located inside the colder environment.

4. The platform of claim 1 that spans above sections of a water container and provides a method and means to sterilize the water.
a. The platform of claim 4 that directs or supports the closed loop system of tubing that pulls water from the container and then pumps the water through a heat exchanger or water block or heat sink to capture or harvest the heat that is generated as a byproduct from a thermoelectric chilling unit.
b. The platform of claim 4 that directs or supports the closed loop system of tubing that pulls water from the container and then pumps the water through a heat exchanger or water block or heat sink to capture or harvest the heat that is generated as a byproduct from a power supply that provides the preferred electrical current to a thermoelectric chilling unit.
c. The platform of claim 4 that directs or supports the closed loop system of tubing that pulls water from the container and then pumps the water through a microfiber filter that removes microbes larger than 0.20 microns and then the platform provides an easy access to replace the submicron filter.
d. The platform of claim 4 that directs or supports a closed loop system of tubing that pulls water from the container and then pumps the water through an inline ultraviolet light source that sterilizes the water and said platform also provides an easy access to service and maintain the UV sterilizer.

5. The platform of claim 1 that spans above sections of a water container and provides a method and means to stimulate an animal to drink water consisting of:
a. A nozzle that exits directly or indirectly from the outflow side of a submerged or inline pump and over the platform and then producing the sound of water stream entering a pool of water.
b. The nozzle that exits directly or indirectly from the outflow side of a submerged or inline pump and breaks the surface tension of the water which causes offensive objects floating on the surface to either sink to the bottom of the container or cause the offending substance to being suspended in the circulating water within the container or go into a chemical solution which will be removed by the filter on the inlet side of a pump.

6. The platform of claim 1 that can be used to tether a netting type container where useful medications, herbs or other chemicals that could be dispersed into the water either above, at or below the water level.
